(19) United States
(12) Patent Application Publication
(10) Pub. No.: US 2008/0193353 A1
(43) Pub. Date: Aug. 14, 2008

(54) Exhaust gas cleaning system

(76) Inventor: Sebastian Hirschberg, Winterthur (CH)

Correspondence Address: Francis C. Hand, Esq.;c/o Carella, Byme, Bain, Gilfillan,, Cecchi, Stewart & Olstein, 5 Becker Farm Road, Roseland, NJ, 07068, US

(21) Appl. No.: 12/009,172

(22) Filed: Jan. 17, 2008

(30) Foreign Application Priority Data
Feb. 9, 2007 (EP) 07102076.2

(51) Int. Cl. B01D 53/94; B01J 19/24; F01N 3/10

(52) U.S. Cl. 423/239.1; 422/180; 60/295

(57) ABSTRACT

An exhaust gas cleaning system for NOₓ containing exhaust gases includes a closed passage in which an NOₓ containing flow of exhaust gas is conveyed from an exhaust gas source to a catalytic converter wherein a metering element is provided upstream of the catalytic converter for the discharge of a liquid reaction solution into the flow of exhaust gas. A vaporiser is arranged downstream of the metering element having surfaces arranged in the flow of exhaust gas onto which the liquid reaction solution is applied and on the surfaces of which the liquid reaction solution is vaporised before the evaporated reaction medium meets the catalytic converter.

This invention relates to an exhaust gas cleaning system. More particularly, this invention relates to a system and method for the cleaning of exhaust gases that contain NOₓ.

Due to new and stricter exhaust gas standards, diesel vehicles will need to have catalytic converters. For example, the new Euro 5 standard applies starting Oct. 1, 2009 and the Euro 6 standard applies starting from 2012. In order to fulfil the Euro 5 standard, smaller transport vehicles will be equipped with exhaust gas cleaning systems, which contain improved catalytic converters. In order to meet the Euro 6 standard, motor vehicles, in particular motor vehicles with a diesel engine are to be equipped with exhaust cleaning systems, which contain improved catalytic converters.

The usual 3-way catalytic converter cannot be used in Otto engines for the reduction of NOₓ in oxygen rich exhaust gases. Engines with oxygen-rich exhaust gas are generally diesel engines and lean-burn engines. A possible alternative for oxygen-rich exhaust gases is the SCR catalytic converter (selective catalytic reduction) in which NO_{x.} in a gas mixture of NO_{x.}-containing exhaust gas and ammonia is largely reduced to N₂ also in the presence of oxygen. However, ammonia cannot be carried in the car and supplied in metered amounts due to its toxic characteristics. For this reason, a system is favoured in the car industry, in which a harmless urea-water solution is broken down in the flow of exhaust gas thermally to ammonia and CO₂. The quantity of ammonia thus produced should be in a stoichiometric proportion to the quantity of NO_{x.} contained in the exhaust gas. For this reason, the metering system has to be able to be relatively precisely regulated or at least controlled and should have short response times.

The metered addition and mixing of an urea-water solution into an exhaust gas is a technical problem for which no satisfactory solution has been found to this day, in particular when only a limited amount of space is available for the exhaust gas cleaning system due to the installation conditions.

Since the load on an engine varies considerably during driving, the operating points of the exhaust gas system of diesel powered vehicles also vary greatly. There can be approximately a factor of 10 between the exhaust gas mass flow at the lowest typical load case and at the highest load. Depending on the engine size and the vehicle size, an exhaust gas mass flow of a maximum of 100 kg per hour can be fed into the exhaust gas cleaning system at a very low load. The exhaust gas mass flow reaches at least 800 kg per hour at the greatest load.

The temperatures can vary between 150° C. in a cold start operation and 700°-750° during the burn-off of a particle filter which is inserted upstream of the exhaust gas cleaning system. The metered addition of the urea-water solution and thus the conversion of the NO_{x.} in the exhaust gas into N₂ is activated from an exhaust gas temperature of 150° C. onwards, in particular from an exhaust gas temperature of 200° C. The mass flow of the urea-water solution, which has to be added in metered fashion to the exhaust gas so that the necessary stoichiometric mixture of NO_{x.} and ammonia is produced, amounts to between 3 and 5% of the petrol consumption.

The pressure loss additionally generated by the metered addition and mixing of the urea-water solution is critical, since the engine power is reduced by any pressure loss in the exhaust system. As a consequence, the smallest possible pressure loss is desired.

Typical exhaust pipe diameters are in the region of 50-100 mm. The spacing of a catalytic converter from the first of possibly a plurality of mixing-in points is typically between 4 and 10 pipe diameters.

Different reactions are possible for the decomposition of the urea-water solution. One possibility is the decomposition into isocyanic acid and ammonia. The isocyanic acid is very unstable and can run through different reactions, such as polymerisation to cyanuric acid. The urea can decompose into biuret (C₂H₅N₃O₂) and ammonia through pyrolysis. Moreover, during the heating of the urea, small amounts of triuret and melamine can occur. Most of these reaction products have melting points at very high temperatures that in some cases are above 300° C. and can, for this reason, lead to layer formation on inbuilt components in the exhaust gas duct during operation and can clog up small gaps and bores. For this reason, no urea-water solution should be admitted into the SCR catalytic converter since, as a result of deposits, the effectiveness of the catalytic converter could be reduced or individual channels of the catalytic converter could even be clogged up completely.

In order that as few undesired side reactions as possible take place and thereby undesired materials result during decomposition of the urea-water solution, special hydrolysis catalysers were developed which favor a direct conversion of urea (CO(NH₂)₂) and water (H₂O) into ammonia (NH₃) and carbon dioxide (CO₂). A hydrolysis catalyser of this kind is described in the EP 0 487 886 B1. According to the patent specification, a situation can be achieved by means of the hydrolysis catalyser in which, during the decomposition of the urea-water solution, the desired hydrolysis reaction takes place almost exclusively at temperatures from 160° C. onwards.

In most of the known technical implementations of a metered addition of a urea-water solution, a liquid spray diffuser is used which atomises the urea-water solution into fine droplets.

A method is described in the U.S. Pat. Nos. 5,968,464 and 6,361,754 in which a urea-water solution is vaporised in a separate pyrolysis chamber and is converted into ammonia and also into CO₂. Not until it is already converted does the gas enter into the actual exhaust system and is then mixed with the flow of exhaust gas. Similar methods are also described in the U.S. Pat. Nos. 6,203,770 and 6,834,498 and in WO 97/36676.

A method for the related exhaust gas cleaning in power stations is described in U.S. Pat. No. 7,090,810 in which a part of the flow of exhaust gas is branched off. A urea-water solution is added to the branched-off flow of exhaust gas in a separate chamber, is vaporised and converted to ammonia and CO₂ by means of hydrolysis. This branch flow of the exhaust gas is then mixed again with the main flow by a fan and a static mixer.

In accordance with the method of WO 98/22209, a liquid urea-water solution is added in droplets to the exhaust gas. The droplets, which are not completely vaporised are removed again from the exhaust gas stream by a droplet separator upstream of the catalyser.

In the WO 98/28070, a method is described in which a urea-water solution is put under pressure and heated before being sprayed into the exhaust gas through a nozzle. The vaporisation is speeded up by the relaxation of the overheated liquid.

A combined vaporiser and distributor is described in WO 2004/079171 A1 that is built up of internally porous ribs. A urea-water solution is intended to be distributed and vaporised in the interior of the porous structure. According to the application, the vaporisation energy is removed out of the flow of the hot exhaust gases by means of thermal conduction through the ribs. The gaseous ammonia can then escape through apertures in the ribs. As a result, these ribs serve simultaneously as a vaporiser and as a distribution grid for the ammonia. The broad temperature range that is required in an application in an exhaust gas cleaning system in a motor vehicle could prove to be problematical with this solution.

The following problems arise in at least some of the already known solutions. For practical reasons, an injection by means of a nozzle dispensing one material is usually selected. The term nozzle dispensing one material is used specially for liquid spray atomisers in which only the liquid to be atomised is pumped through the nozzle. In dual material dispensing nozzles, a gas is also pumped into the nozzle, in addition to the liquid to be diffused, whereby the diffusion can be improved. A compression apparatus is admittedly required for the compression of the gas. Nozzles dispensing one material of this kind typically produce droplet spectra with a Sauter diameter of 70-90 μm, however, individual large droplets of up to 200 μm are also produced. Due to the pollution or clogging problems described above, care has to be taken that no droplets can enter the catalytic converter. The flight time of the droplets to the catalytic converter only amounts to a few milliseconds which is not sufficient to vaporise larger droplets during the flight phase. For this reason, at least the larger droplets have to be precipitated out of the exhaust gas and have to vaporise in a film of liquid. To this end, a combined mixing and vaporising element is used. In order that the droplets in the flow are actually precipitated at this element, the flow has to be deflected through the element. This necessitates a certain minimum pressure drop and thus a reduction of the engine power. In practice, the use of mixers with a crossed channel structure in accordance with DE 2 205 371 as a combined mixer and vaporiser has proved itself. The pressure drop of a mixer with a crossed channel structure is admittedly higher than the pressure drop of a mixer element by means of which a deflection of the flow in the passage can be achieved via guide elements.

Accordingly, it is an object of the invention to avoid the discharge of droplets that contain urea-water solution into a catalytic converter, in particular into a SCR catalytic converter. Should droplets of the urea-water solution enter into the catalytic converter, this would result in the clogging of the catalytic converter and thus to a degradation/deterioration of the catalytic effect.

Briefly, the invention provides an exhaust gas cleaning system for NOₓ containing exhaust gases from engines, particularly diesel engines. The system comprises a closed passage for conveying a NOₓ containing flow of exhaust gas from an exhaust gas source, i.e. a diesel engine, at least one metering element for the introduction of a liquid reaction solution into the flow of exhaust gas, a vaporiser downstream of the metering element having surfaces in the flow of exhaust gas onto which the liquid reaction solution is applied and vaporised and a catalytic converter downstream of the vaporiser for receiving the flow of exhaust gas and the vaporised liquid reaction solution.

The application of a liquid reaction solution takes place in accordance with a particularly advantageous embodiment directly on the surface of the vaporiser. The metering element is thus positioned at the side of the vaporiser facing the flow. The vaporiser is preferably formed as a film vaporiser.

A mixer can be arranged following the vaporiser and includes a static mixer element. The mixer is arranged downstream of the vaporiser in order to create a homogenous distribution of the liquid reaction medium in the flow of exhaust gas.

A particle filter is arranged between the exhaust gas source and the metering element in order to precipitate dust and particles that impair the function of the catalytic converter.

In accordance with a further embodiment, the film vaporiser is simultaneously formed as a mixer. In accordance with a further embodiment the vaporiser and/or the mixer have a crossed channel structure, which is in particular designed in accordance with DE 2 205 371. The surfaces of the vaporiser comprise thermally conducting material, whereby the liquid films forming on the surface of the guide elements vaporise completely after a short path by means of the heat exchange between the guide element and the liquid film. In addition to steels, which preferably contain alloying elements for the increase of the thermal conductivity, other well conducting metallic materials, in particular copper alloys or ceramics with high thermal conductivity are used.

In accordance with a further embodiment, the surfaces of the vaporiser include a plurality of guide elements that are arranged substantially along the main flow direction and can be at least partially ribbed. The guide elements are aligned in the form of a star about a guide element arranged in a central position of the passage. The guide element is, in particular, formed as an annular guide element. At least one part of the metering element is catalytically active, and particularly catalytically active for hydrolysis.

At least one metering element projects into the passage for the flow of exhaust gas. A plurality of metering elements can also project into the passage for the uniform distribution of the liquid reaction medium in the passage. The metering element contains a feed line for the application of the liquid reaction medium on the surface of the vaporiser, and is in particular a tube with metering apertures through which the liquid reaction medium, i.e. in particular a urea-water solution is guided onto the surfaces of the vaporiser.

A metering element may also use a distributing element formed as a capillary with an outlet aperture or a nozzle. A curved segment may also be provided in the region of the outlet aperture, so that the liquid reaction solution can be distributed ideally on the surface of the vaporiser.

The feed line feeds a plurality of distributing elements for the improved distribution of the liquid reaction solution, so that the number of the feed points for the liquid reaction solution arranged in the passage is increased. Due to the danger of blockage by unwanted deposits in the lines in which urea-water solution is conveyed, care has to be taken that the lines or narrow gaps through which urea-water solution flows, cannot heat up to temperatures of over 100° C. This can be achieved by various measures, wherein the metering element includes means to prevent premature vaporisation of the liquid reaction medium. The means is in particular formed as a thermal insulation relative to the flow of exhaust gas, for example as a thermal insulation of the wall of the metering element (pin). The means can include a thermoelectric Peltier cooling element for the cooling of the liquid reaction medium. Alternatively, the means effects a tempering of the liquid reaction medium by means of a cooling circuit or through a continuous recirculation of a part of the urea-water solution in a cooling jacket. The metering element can contain a coolant passage with a coolant line for the supply of coolant and also a coolant line for the removal of coolant. The passage can be formed as a cylindrical tube or “pin”, in which the distributing element is arranged, whereby cooling fluid can flow around the distribution element on all sides. The passage may be U-shaped and/or have a partition wall. The passage can also be bounded by two tubes extending concentrically into one another so that a double tube results.

It is particularly preferred when the exhaust gas cleaning system is used in a vehicle, in particular in passenger car or a transport vehicle, which is equipped with a diesel engine that a situation is avoided in which droplets of the liquid reaction solution are carried along into the catalytic converter as, otherwise, a pollution or blockage of the catalytic converter may result.

The invention also provides a method for the cleaning of exhaust gases that contain NOₓ. This method includes the steps of introducing a NOₓ containing flow of exhaust gas from an exhaust gas source into a passage, applying a liquid reaction solution onto a vaporiser to vaporise the liquid reaction solution and reacting the vaporised reaction solution with NOₓ in a catalytic converter. The liquid reaction solution is preferably a urea-water solution.

Prior to entry into the catalytic converter, the flow of exhaust gas charged with the vaporised reaction medium is mixed, for example in a mixer. The NOₓ is reduced in the catalytic converter with the ammonia contained in the gas mixture to N₂ in spite of the presence of oxygen.

These and other objects and advantages of the invention will become more apparent from the following detailed description taken in conjunction with the accompanying drawings wherein:

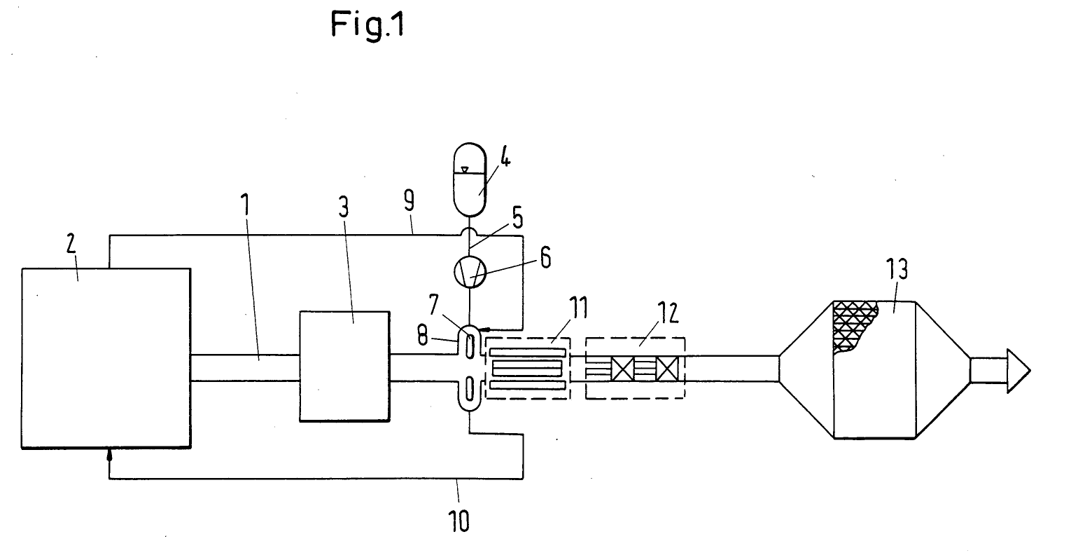

FIG. 1 illustrates a schematic view of an exhaust gas cleaning system in accordance with the invention;

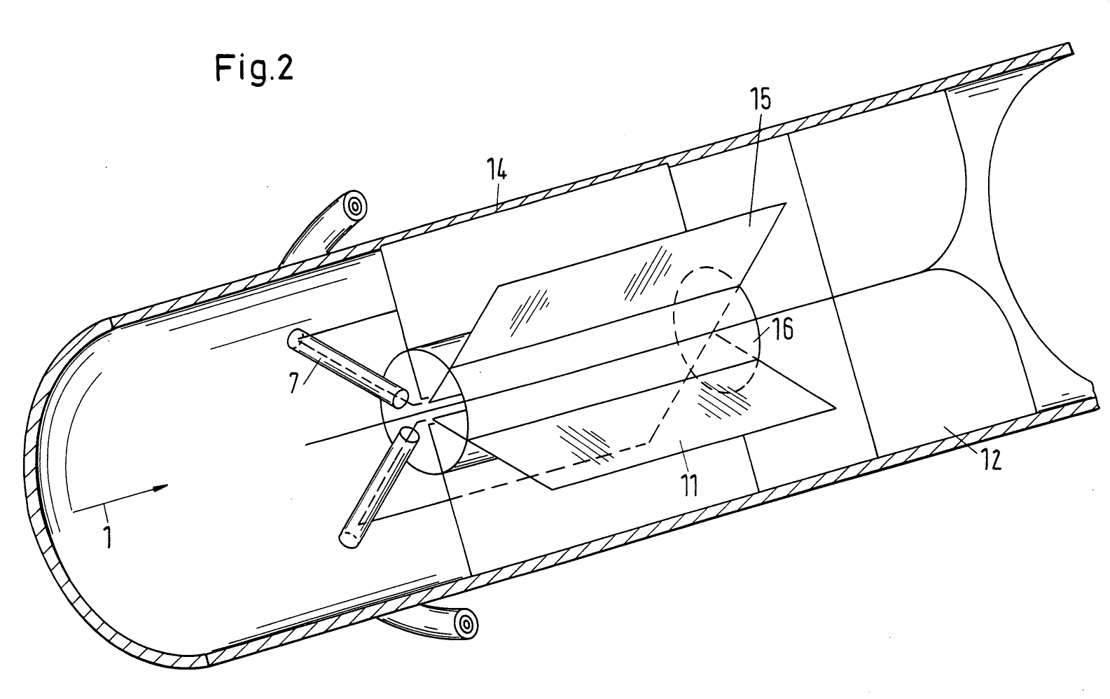

FIG. 2 illustrates a partially broken-away perspective view of the metering elements, vaporiser and mixer in a closed passage of the system of FIG. 1;

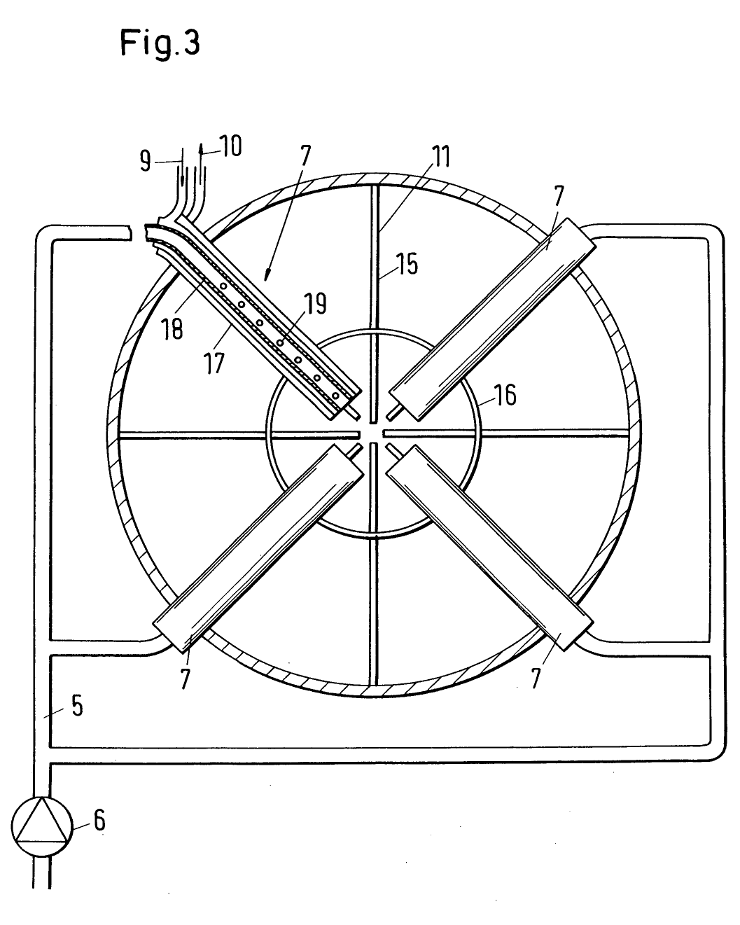

FIG. 3 illustrates a part cross-sectional view of the metering elements and vaporiser of FIG. 2 in the flow direction of the exhaust gas;

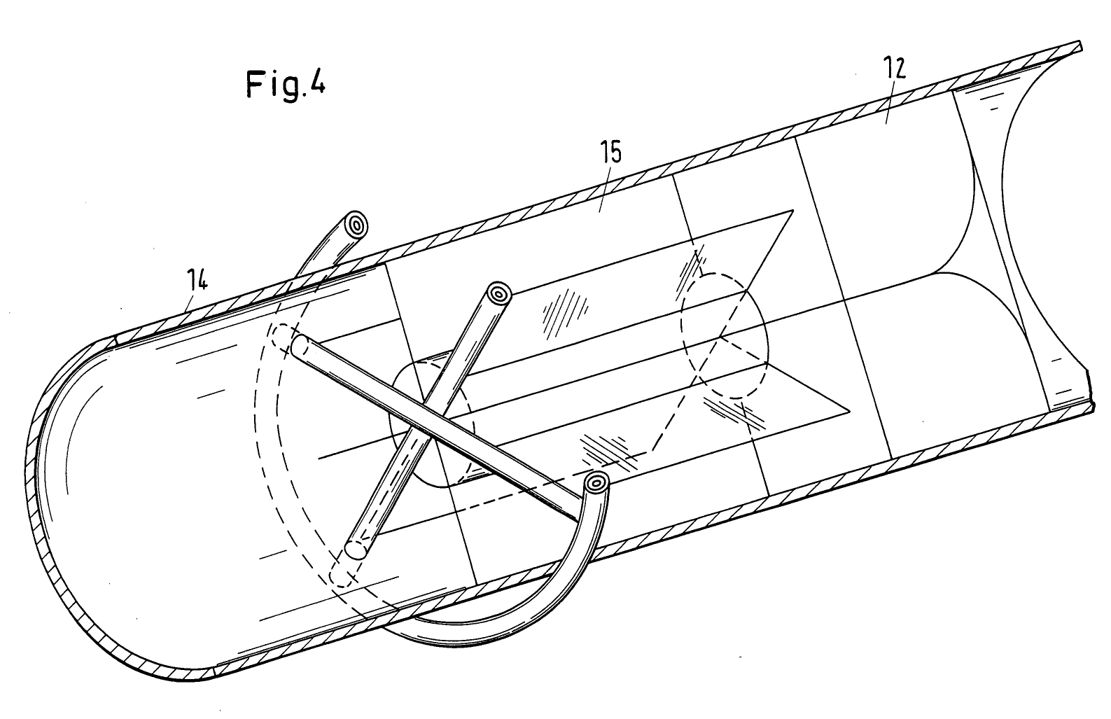

FIG. 4 illustrates a perspective view of a modified arrangement of metering elements, vaporiser and mixer in accordance with the invention;

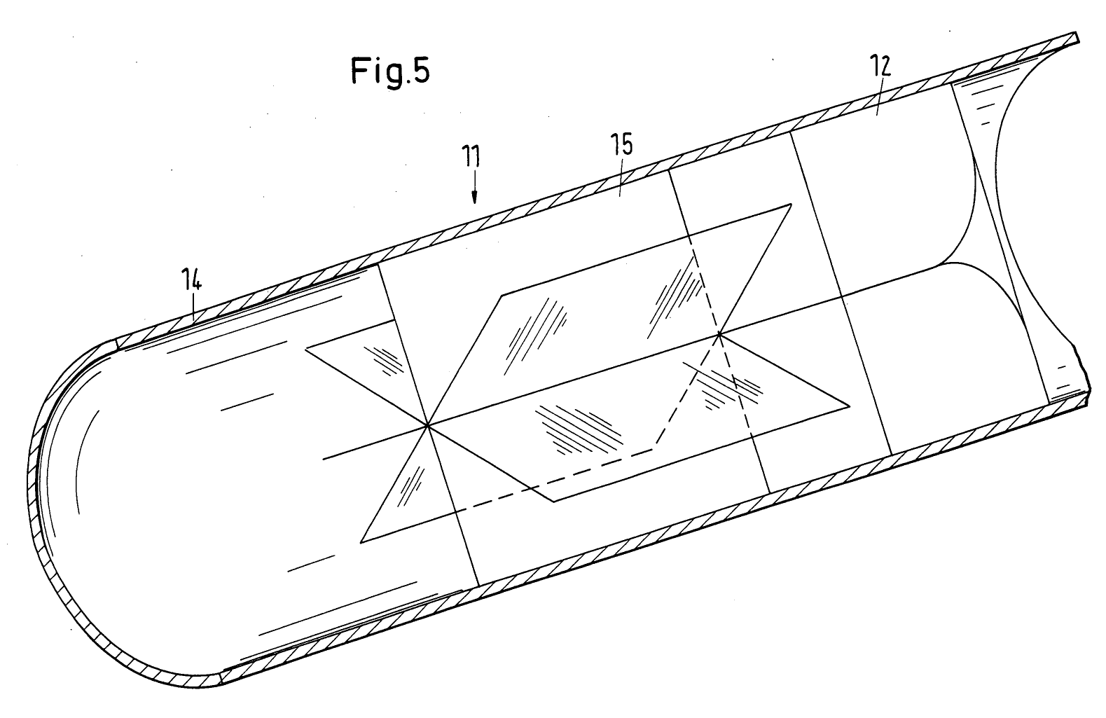

FIG. 5 illustrates a perspective view of a further modified arrangement of vaporiser and mixer in accordance with the invention;

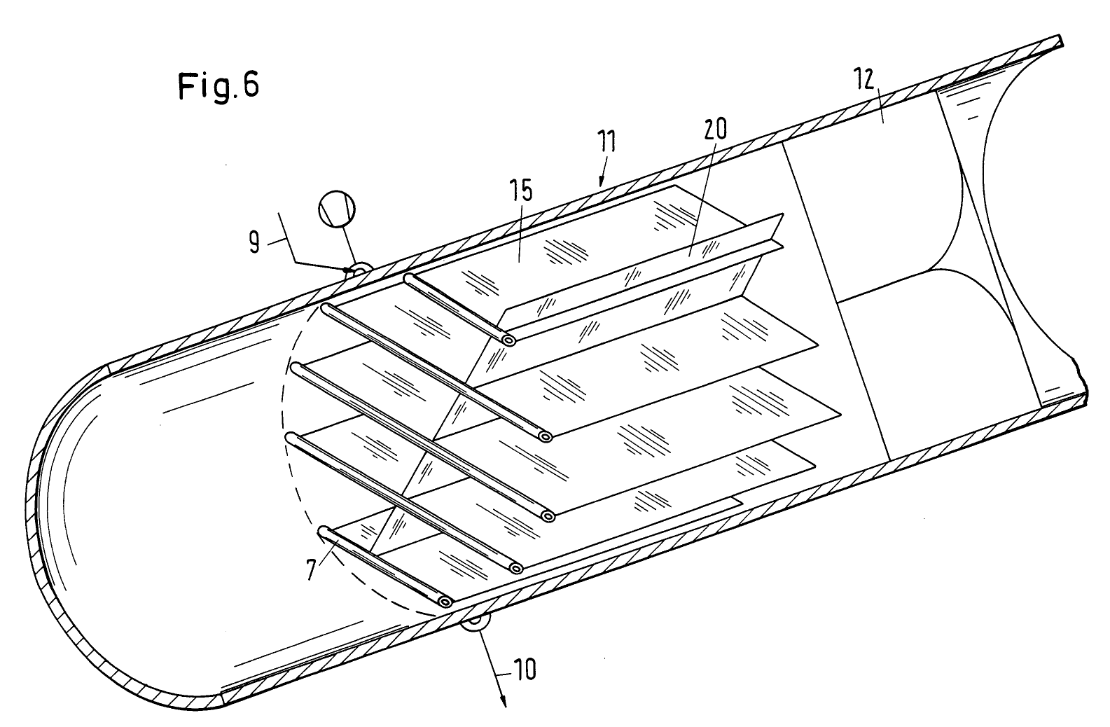

FIG. 6 illustrates a perspective view of a further modified arrangement of metering elements, vaporiser and mixer in accordance with the invention;

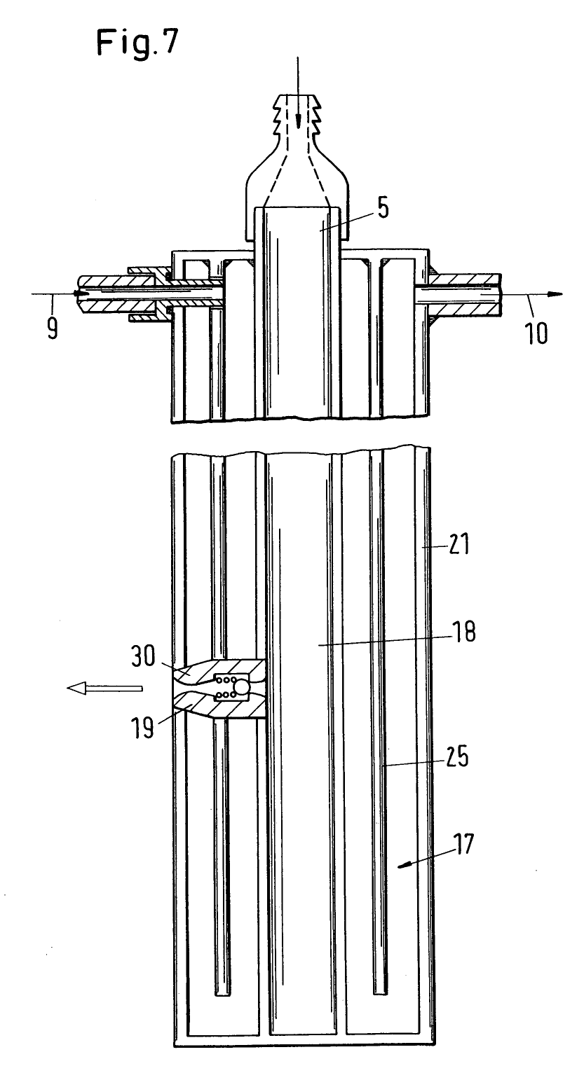

FIG. 7 illustrates a part cross-sectional view of a metering element in accordance with a first embodiment of the invention;

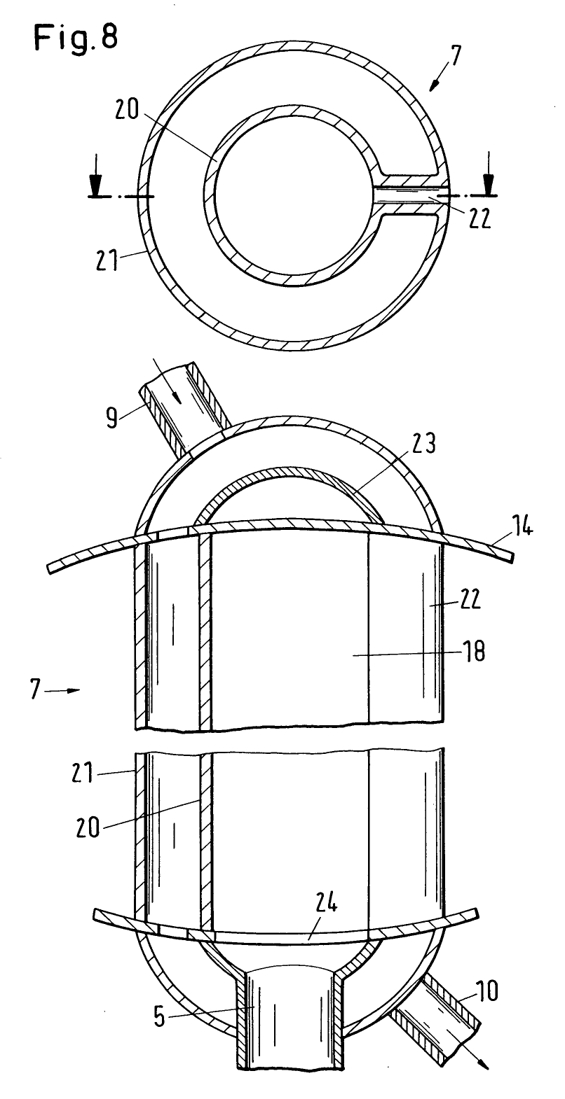

FIG. 8 illustrates a part cross-sectional top view and a part cross-sectional side view of a metering element in accordance with a second embodiment

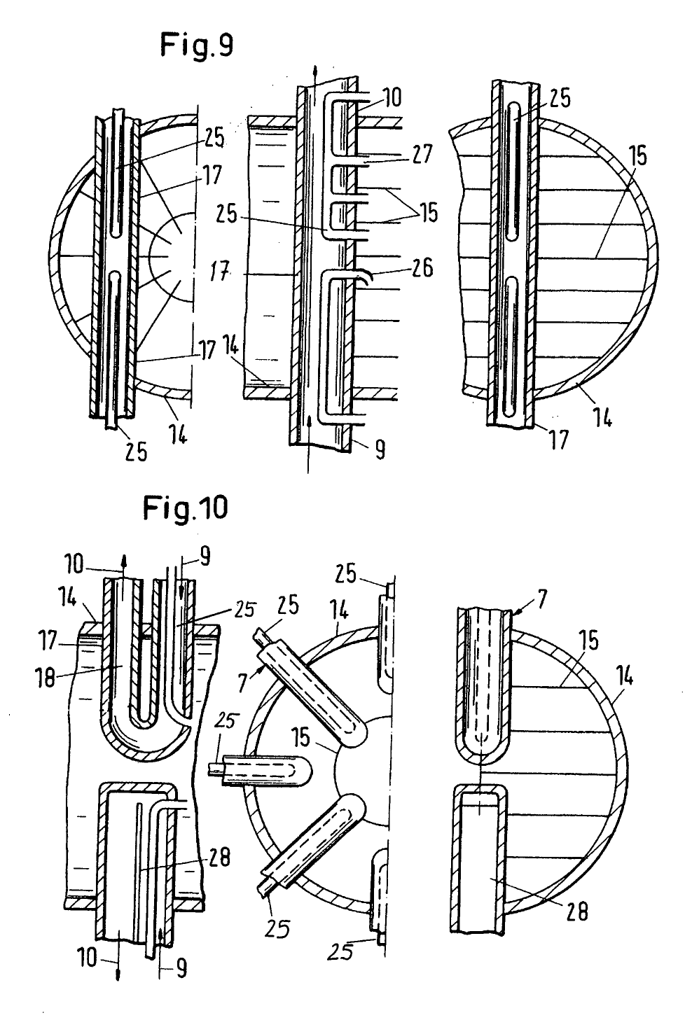

FIG. 9 illustrates three part cross-sectional views of a metering element in accordance with a third embodiment;

FIG. 10 illustrates three part cross-sectional views of a metering element in accordance with a fourth embodiment; and

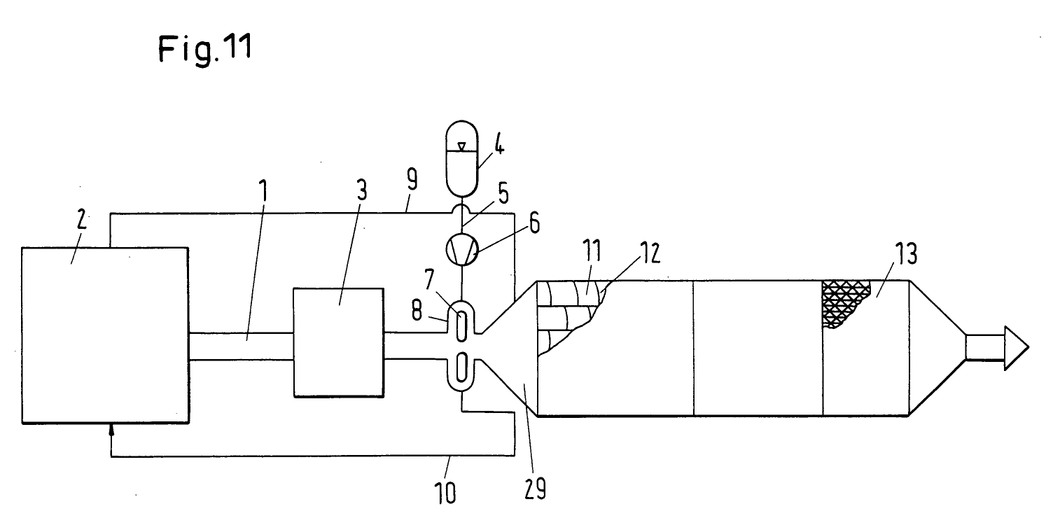

FIG. 11 illustrates a schematic view of a further variant of an exhaust gas cleaning system in accordance with the invention.

Referring to FIG. 1, the exhaust gas cleaning system for cleaning a NOₓ containing flow of exhaust gas 1 from an exhaust gas source, such as a diesel engine 2 employs a liquid reaction medium, in particular a urea-water solution, and a catalytic converter 13, in particular a SCR catalytic converter.

The exhaust gas cleaning system includes a dust and particle filter 3 downstream of the exhaust gas source 2 through which the flow of exhaust gas 1 emitted from the exhaust gas source 2 passes, a reservoir 4 containing a liquid reaction medium which includes a urea-water solution, and a metering element 7 for metering the urea-water solution into the filtered exhaust gas flow. The urea-water solution is kept in a reservoir 4 until used and is added to the dust and particle-free flow of exhaust gas 1 during operation of the exhaust gas cleaning system.

The reservoir 4 is connected to a metering element 7 via a feed line 5, by means of which the liquid reaction medium is supplied to the metering element 7. A conveying means, in particular a pump 6, is provided in the feed line 5 for increasing the feed pressure and/or for the improved conveying of the liquid reaction medium.

The metering element 7 is surrounded by a cooling jacket 8 into which a coolant line 9 discharges and which a further coolant line 10 leaves for cycling a cooling medium through the jacket 8. As shown, the cooling medium is branched off from the coolant circuit of the engine 2.

Following the metering element 7, the exhaust gas cleaning system includes a film vaporiser 11 provided in the flow of exhaust gas. The vaporiser 11 is a film vaporiser which draws the energy needed directly from the exhaust gas. A vaporiser of this kind can only be used if dust and particles are almost completely eliminated from the flow of exhaust gas 1 upstream of the particle filter.

A mixer 12 is provided following the vaporiser 11, which is, in particular, a static mixer. After running through the mixer 12, the flow of exhaust gas and the vaporised reaction medium distributed therein are introduced into the catalytic converter 13.

The complete conversion of the NOₓ with the urea-water solution to N₂ takes place in the catalytic converter 13 by means of a reduction reaction. The exhaust gas escaping from the catalytic converter 13 can be discharged into the environment after a possible further cooling step, should the exhaust gas have no other components which require a separate after treatment.

Referring to FIG. 2, in one embodiment, a plurality of metering elements 7, a film vaporiser 11 and a mixer 12 are placed within a closed passage 14 through which the flow of exhaust gas 1 is guided. The passage 14 is partially cut open in order to make the installations visible.

Each metering element 7 is formed as a tube, which has one or more outlet openings (not illustrated) through which the liquid reaction medium, i.e. the urea-water solution, reaches the surfaces of the vaporiser 11.

The vaporiser 11 contains a plurality of guide elements 15, 16, which are formed as thin-walled guide elements and extend in the flow direction in such a way that they offer the lowest possible flow resistance. The guide elements 15 are in the form of plates that are secured radially on the inner surface of the passage 14 at their outer edges, for example by a welded connection. The guide element 16 is in the form of an annular tube that passes through the guide elements 15 in concentric relation to the passage 14 to increase the form stability and also for the improvement of heat exchange between the radial guide elements 15. Thus, the cross-section of the passage 14 is divided by the guide elements 15,16 into a plurality of passage elements designed as similarly as possible. In this connection, the surfaces of the guide elements 15,16 preferably extend in the flow direction which results in a minimal pressure loss of the film vaporiser 11.

In the illustrated embodiment, the guide elements 15 are shown as flat surfaces. However, guide elements with surface structures, such as zigzag profiles or wavelike structures, can also be provided for an increase of the heat exchange surface at an, at most, insubstantial increase in the pressure loss. The ridges (crests or edges in the zigzag profiles) are preferably aligned in the flow direction, however, the ridges can also be inclined at an angle to the flow direction if this does not result in a substantial increase of the pressure loss.

Referring to FIG. 3, wherein like reference characters indicate like parts as above, the pump 6 ay deliver the urea-water solution in parallel to four metering elements 7 disposed equidistantly and radially of the passage 14 for the flow of exhaust gas.

Each metering element 7 (only one of which is so illustrated) includes a passage 18 for the urea-water solution and a cooling jacket 17 in which a coolant circulates being supplied via a coolant line 9 and removed via a coolant line 10.

The passage 18 is a continuation of the feed line 5 for the urea-water solution and distributes the urea-water solution onto the surfaces of the guide elements 15 by means of distributor elements 19. If the distributor elements 19 are nozzles 30 (see FIG. 7), the urea-water solution is applied onto the surface of the guide elements 15 as a spray mist. The spray mist wets this surface and the formation of continuous liquid films or trickles can result. The surface, which would be required to transfer the energy for the vaporisation of the liquid by means of heat transfer out of the hot exhaust gas directly into the liquid film, is relatively large. However, with the given small liquid load, it is difficult to distribute the liquid film on the surface, i.e. to wet the surface completely. Due to the good thermal conductivity of the vaporiser 11, the heat is initially transferred indirectly out of the exhaust gas into the vaporiser 11, is transported by thermal conduction within the vaporiser structure to the trickle and introduced there into the trickle which is flowing on the surface of the guide element 15. A vaporiser of this kind operates even when the liquid film only wets a very small part of the surface of the guide element 15 and/or of the annular guide element 16.

The vaporiser should be constructed in such a way that the guide elements 15, 16 on the one hand have a large surface for the thermal transfer from the exhaust gas into the vaporiser body, which is formed by the guide elements 15, 16, for example by a suitable rib arrangement and/or by the surface increasing structures mentioned in connection with FIG. 2. On the other hand, the guide surfaces 15, 16 should be constructed in such a manner that the heat conduction in the vaporiser 11 only has to take place over short distances. All of the surfaces of the guide elements of the vaporiser 11 are substantially aligned in the flow direction, so that the flow resistance of the vaporiser body as a whole remains slight.

The cross sections of the flow passages, which are formed through the vaporising body are, in accordance with a particularly preferred embodiment, distributed over the overall cross-section of the passage 14, if possible at uniform distances from one another, so that the film vaporiser 11—as an obstruction around which the exhaust gas flowing in the passage has to flow—does not lead to a one-sided flow distribution in the exhaust gas passage. The surface of the guide element on which the urea-water film flows is preferably aligned horizontally upwardly so that droplets cannot form and detach due to the effects of gravity. The surface of the collection of guide elements of the vaporiser should be selected to be so large in particular that the heat transfer function can be guaranteed without problems. On the other hand, the volume and the blocked proportion of the cross-section is preferably to be selected to be as small as possible, or rather the hydraulic diameter is to be selected to be as large as possible, so that the flow resistance of the vaporiser remains slight.

The part of the vaporiser 11 on which the film flows can be coated with a catalytic converter for hydrolysis which effects a preferred conversion of the urea-water solution into NH₃ and CO₂.

Referring to FIG. 4, wherein like reference characters indicate like parts as above, the metering element 7, instead of being in the form of an arm extending into the passage 14, passes through the passage 14. A plurality of metering elements of this kind are arranged crosswise or parallel to one another (not illustrated). Distributing elements (not visible illustrated), guide the liquid reaction solution onto the surfaces of the guide elements 15 and/or of the guide elements 16.

Referring to FIG. 5, wherein like reference characters indicate like parts as above, the guide elements 15 of the film vaporiser 11 may be aligned in the form of a star and may be fixed in their position centrally by a holding element located on the axis of the passage 14 or through a connection to the wall of the passage 14. The guide elements 15 can also be selectively attached to the inner wall of the passage 14.

Referring to FIG. 6, wherein like reference characters indicate like parts as above, in another embodiment, the film vaporiser 11 includes a plurality of guide elements 15 that extending in the flow direction in parallel to one another and at substantially the same distances from one another. At least one support element 20 is provided, so that the spacing of the guide elements 15 does not alter in operation. In addition, metering elements 7 are arranged directly upstream of at least some part of the guide elements 15.

By means of the metering elements 7 at least one surface of the guide elements 15 is wetted with liquid reaction solution, so that a film or trickle forms. In accordance with a preferred arrangement, the guide elements 15 are substantially aligned horizontally so that the film forms on the upper surface of the guide element. The film is driven forwards along the surface by the flow of exhaust gas and is vaporised by the heat transfer from the guide element 15 to the film by thermal conduction and by the heat transfer by convection on the surface at the film side.

The film or the trickle can be produced in different ways. On the one hand, liquid can be atomised by means of a nozzle or can be sprayed as a jet in the direction of the vaporiser and deposited on the surface of the vaporiser. An embodiment for a metering element with distributor elements 19, which are formed as a nozzle 30, is shown in FIG. 7. The distributor element 19 can also include means for the atomisation of the liquid reaction medium.

Referring to FIG. 7, the metering element 7 of FIGS. 2 and 3, projects into the flow of the exhaust gas and includes a passage 18, a cooling jacket 17 and also at least one distributor element 19 that communicates with the passage 18.

The cooling jacket 17 is formed by two tubes 21, 25 that are concentrically arranged around the passage 17 in the feed line 5. As illustrated, the tubes 21, 25 are closed at the lower ends and the inlet coolant line 9 is connected to the inner tube 25 while the the outer tube 21 is connected to the outlet coolant line 10. Thus, the coolant is led on a substantially U-shaped path inside the cooling jacket 17 from the inlet through the coolant line 9 until entering into the coolant line 10.

The coolant passage is thus bounded by the jacket surfaces of the three tubes. Since the coolant passage is arranged around the passage 18, bores are provided for the distributor element 19 or elements in which the distribution elements 19 are received. As illustrated, each distributor element 19 communicates with the passage 18 to deliver the liquid reaction solution radially outwardly of the passage 18 and passes through the tubes 21, 25 so that coolant can flow around the distributor 19 on all sides.

In accordance with a not-illustrated variant, the coolant passage need only partially surround the passage and/or distributor element if the distributor element includes a nozzle 30 (see FIG. 7). The distributor element directs the flow of the liquid reaction solution onto the surface of the guide elements 15 as described above with respect to FIG. 3, FIG. 4 or FIG. 5 (without metering elements 7).

In another embodiment, the liquid reaction solution can be guided directly to the head end of the vaporiser 11 by means of a feed line and a film can be produced there. An embodiment for an associated metering element is shown in FIG. 8. This metering element can be used in an arrangement in accordance with FIG. 6 for example. The metering element 7 is shown in a section in the upper part of FIG. 8. A longitudinal section of the metering element is shown in the lower part of FIG. 8.

The metering element 7 includes two tubes 20, 21 arranged in concentric relation to one another. The inner tube 20 defines a passage 18 that communicates with the feed line 5 to receive the liquid reaction solution and has an aperture 22, which is formed as a slot, through which the liquid reaction solution exits in the direction of the film vaporiser 11 (not illustrated).

The feed line 5 opens into an annular passage 23 arranged around the passage 14, which serves for the distribution of the liquid reaction solution over the periphery. Liquid reaction solution flows through this into the arrangement of metering elements, as shown in FIG. 6. At all points at which a metering element is fitted, the passage 14 contains a bore 24, so that liquid reaction solution can enter into the metering element 7. A coolant passage is arranged around the passages 18, 23 that conduct the liquid reaction solution. The coolant passage includes an annular passage which is arranged around the annular passage 23 and also the intermediate space between the outer and inner tube 20. The coolant is supplied via the coolant line 9 and removed via the coolant line 10.

If only a small part of the vaporiser 11 is wetted by the film of the urea-water solution or if the flow profile is irregular, the ratio between ammonia and NOₓ generated there is not constant over the whole cross-section of the passage 14. In this case, the film vaporiser 11 is followed by a suitable static mixer 12. The static mixer 12 intensifies the turbulence present in the passage 14 and generates additional, intensive, large vortices, which support the large volume distribution of the reaction solution transverse to the main flow direction, in other words in particular of the ammonia forming from the urea-water solution.

Different constructions for mixers of this kind come into question. Static mixers, which do not bring about a breakaway of the flow are particularly favorable with regard to the pressure loss. An example of a mixer with particularly favorable pressure loss is described in DE 195 39 923 C. Here vortex-producing surfaces are arranged in such a way that they do not exhibit any breakaway of the flow at all. However, only one described guide plate arrangement can be used for exhaust gas passages in each case, which produces a large vortex in the passage and thereby brings about a mixing over the periphery and over the entire tube cross-section. If the exhaust gas tube has exhaust manifolds between the vaporiser and the catalytic converter, the secondary flow generated by these exhaust manifolds can also be used for the mixing. A tube flow with spin which is guided through an exhaust manifold, has moreover a lower pressure loss than a spin-free tube flow through the same exhaust manifold. A mixer, which produces a large vortex and thus a spin in the tubular flow, could for this reason perhaps even reduce the pressure loss of the flow of exhaust gas behind the vaporiser.

Referring to FIG. 9, wherein like reference characters indicate like parts as above, the metering element is in the form of at least one capillary 25 (tube), by means of which a liquid reaction medium, in particular a urea-water solution, is distributed onto a guide element 15 and a cooling jacket 17, i.e. a tube that extends between two oppositely disposed apertures in the wall of the passage 14.

The middle part of FIG. 9 shows a section of a longitudinal section through the passage 14. As illustrated, the tube 17 extends through the passage 14 and communicates at opposite ends with the inlet and outlet coolant lines 9,10, respectively, and functions as a cooling jacket so that the coolant may flow over a pair of capillaries 25. In this connection, as illustrated the upper capillary has a plurality of outlet apertures 27 disposed in parallel and the lower capillary 25 has a single outlet aperture.

Each capillary 25 receives a flow of the liquid reaction solution from the feed line 5 (see FIG. 1) and has a curved segment 26 at the place where the liquid reaction solution emerges (illustrated in the lower capillary only), whereby the liquid reaction solution strikes the guide element 15 at an angle, so that the liquid reaction solution wets the guide element 15.

The left-hand part of FIG. 9 and the right-hand part of FIG. 9 show two different arrangements of the guide elements 15, which correspond to the arrangements shown in FIG. 2 and FIG. 6, respectively.

Furthermore, as shown in the left-hand part of FIG. 9, the capillaries 25 and the cooling jacket 17 surrounding these capillaries 25 do not need to be arranged centrally of the passage 14.

Referring to FIG. 10, wherein like reference characters indicate like parts as above and wherein the left-hand part of FIG. 10 corresponds to the middle part of FIG. 9, with the guide elements 15 having been omitted in this illustration, the capillaries 25 containing the reaction medium, their cooling jackets 17 and their arrangement in the passage 14 may be further modified.

In accordance with the variant shown in the upper part of FIG. 10, a U-shaped cooling jacket 17 projects into the cylindrical passage 14 to conduct the coolant in a U-shaped passage 18 and one or more capillaries 25 extends within one leg of the U-shaped cooling jacket 17 to an outlet in the wall of the jacket 17 within the cylindrical passage 14.

Coolant is fed to the cooling jacket 17 via the coolant line 9 and leaves the metering element via the coolant line 10.

In the variant shown in the lower part of FIG. 10, a tube projects into the cylindrical passage 14 and is provided with a partition wall 28 in the middle of the tube to separate the tube into an inflow path and an outflow path. The inflow path communicates with the coolant inlet 9 and the outflow path communicates with the coolant outlet 10. One or more capillaries 25 is located within the inflow path to conduct the liquid reaction solution into the cylindrical passage 14.

The middle and right-hand parts of FIG. 10 show views of one half of the passage 14 in the flow direction with a metering element 7 and a guide element 15. As in FIG. 9, two different arrangements of guide elements are illustrated and also different arrangements of metering elements 7.

The middle part of FIG. 10 shows metering elements 7 peripherally distributed in the shape of a ring at the periphery of the passage 14, which project into the passage 14 and can be designed in accordance with FIG. 3, FIG. 7, or FIG. 10, left-hand part. As in FIG. 9, a metering element 7 can include a plurality of capillaries 25 or capillaries with a plurality of outlet apertures.

The right-hand part of FIG. 10 also shows the combination of different types of metering elements 7 in a passage 14. For example a metering element including a cooling jacket 17, which is designed as a U-shaped passage 18, can be combined with a metering element, which includes a cooling jacket 17 with a passage 18 which contains a partition wall 28.

Referring to FIG. 11, wherein like reference characters indicate like parts as above, in a further embodiment, the film vaporiser 11 is formed as a mixer with a crossed channel structure as is described in DE 2 205 371. A mixer of this kind contains at least one mixing element, which is permeated by liquid media flowing in the same direction. The mixing element includes layers forming flow passages which touch each other. The longitudinal axes of the flow passages with one layer extend substantially parallel to one another at least in groups. The flow passages of at least two adjacent layers are at least partially open relative to one another. The longitudinal axes of the flow passages of adjacent layers are inclined relative to one another in accordance with an advantageous embodiment. The layers of adjacent mixer elements can be inclined relative to one another at an angle about the longitudinal axis of the mixer.

The film vaporiser 11 and the mixer 12 are thus combined into one component which is located between the upstream metering element 7 and the downstream catalytic converter 13. In the gas cleaning system of FIG. 11, a diffuser 29 is arranged between the metering element 7 and the film vaporiser 11. The diffuser 29 can contain guide elements, which can likewise be accorded the function of a film vaporiser. According to another, not illustrated variant, the metering element is located directly in front of the film vaporiser downstream of the diffuser 29.

The arrangement in accordance with FIG. 11 has the further advantage that the arrangement of the combined mixer and film vaporiser can take place directly before the catalytic converter 13 and thus a larger cross-section is available, as a result of which the loss of pressure can be reduced considerably. A thorough mixing of the vaporised reaction medium with the flow of exhaust gas can be achieved by means of a mixer/vaporiser 11, 12 with a crossed channel structure, so that an intermediate space between the mixer/vaporiser 11, 12 and the catalytic converter can be omitted. A film of liquid is applied to the mixer/vaporiser by means of the metering elements 7 which is vaporised there and simultaneously mixed. The variants of FIG. 11 can be combined in any way desired with the embodiments described in connection with the FIGS. 1 to 10 for the arrangement, the type or the number of the metering elements and with the embodiments for the film vaporiser.

In all cases, the construction has to be selected in such a way that all liquid reaches the vaporiser exclusively and from there not a drop can be torn away by the current. To guarantee this with the solution using an atomising nozzle is not easy.

If the urea-water solution is guided directly to the vaporiser by means of a line, this line should be temperature controlled by means of a separate circuit and additionally eventually also insulated, since a situation must be prevented under all circumstances in which the urea-water solution vaporises inside the metering elements. For the cooling, one part of the coolant circuit of the motor can be branched off for example and circulated through this line. According to an advantageous embodiment, the metering of the urea-water solution takes place by means of a metering element formed as a metering pin, which points directly from the edge of the exhaust tube forming the closed passage to the metering point on the surface of a guide element of the film vaporiser, whereby a film of liquid is applied to this surface. The metering pin includes a concentric double tube for the cooling water. The cooling water flows into the inside of the tubes to the metering point and is deflected there and led back again through the gap between the outer and inner tube. The actual line for the urea-water solution can be realised as capillaries inside the cooled line due to the low mass flow. The mass flow can be controlled by means of a simple pump. In order to effect a good pre-distribution of the ammonia in the exhaust gas passage, trickles can be generated in a plurality of places on the vaporiser. For this, a plurality of metering elements distributed on the periphery of the passage are provided in particular. If the feed line to the metering elements is temperature controlled by the engine cooling circuit, it should also be ensured that no problems with obstruction of the capillaries for the metering arise in this connection. If the overall metering is to take place via a single pump but via a whole bundle of capillaries then the volumetric flow into the different metering points can be controlled via the length of the individual capillaries.

What is claimed is:

1. An exhaust gas cleaning system for NOₓ containing exhaust gases, said system comprising
a closed passage for conveying a NOₓ containing flow of exhaust gas from an exhaust gas source;
at least one metering element for the introduction of a liquid reaction solution into the flow of exhaust gas,
a vaporiser downstream of said metering element relative to the flow of exhaust gas, said vaporiser having surfaces arranged in the flow of exhaust gas onto which the liquid reaction solution is applied and vaporised; and
a catalytic converter downstream of said vaporiser for receiving the flow of exhaust gas and the vaporised liquid reaction solution.

2. An exhaust gas cleaning system in accordance with claim 1 wherein said vaporiser is a film vaporiser.

3. An exhaust gas cleaning system in accordance with claim 1 further comprising a particle filter disposed upstream metering element for filtering the flow of exhaust gas.

4. An exhaust gas cleaning system in accordance with claim 1 further comprising a mixer downstream of said vaporiser for receiving and mixing the flow of exhaust gas and the vaporised liquid reaction solution.

5. An exhaust gas cleaning system in accordance with claim 4 wherein said mixer includes a static mixer element.

6. An exhaust gas cleaning system in accordance with claim 1 wherein said vaporiser is formed as a mixer.

7. An exhaust gas cleaning system in accordance with claim 4 wherein at least one of said vaporiser and said mixer has a crossed channel structure.

8. An exhaust gas cleaning system in accordance with claim 1 wherein said surfaces of said vaporiser comprise a thermally conducting material.

9. An exhaust gas cleaning system in accordance with claim 8 wherein said thermally conducting material includes at least one of a steel, a steel alloy, a copper alloy and a ceramic of high thermal conductivity.

10. An exhaust gas cleaning system in accordance with claim 1 wherein said surfaces of said vaporiser include a plurality of guide elements disposed along the main flow direction of the flow of exhaust gas.

11. An exhaust gas cleaning system in accordance with claim 10 wherein at least one part of at least some of said guide elements is ribbed.

12. An exhaust gas cleaning system in accordance with claim 1 wherein said vaporiser has a plurality of guide elements aligned in the form of a star about a guide element arranged in a central position of a passage for the flow of exhaust gas through said vaporiser.

13. An exhaust gas cleaning system in accordance with claim 1 wherein said vaporiser has a plurality of guide elements, at least some of said guide surfaces having a catalytically active part thereon.

14. An exhaust gas cleaning system in accordance with claim 13 wherein said catalytically active part is a catalytically active surface for hydrolysis.

15. An exhaust gas cleaning system in accordance with claim 1 wherein said at least one metering element includes a feed line for the introduction of the liquid reaction solution into the flow of exhaust gas and a distributing element in communication with said feed line for distributing the liquid reaction solution onto said surfaces of said vaporiser.

16. An exhaust gas cleaning system in accordance with claim 15 wherein said distributing element is a capillary with an outlet aperture directed towards said surfaces of said vaporiser.

17. An exhaust gas cleaning system in accordance with claim 16 wherein said capillary has a curved segment in the region of said outlet.

18. An exhaust gas cleaning system in accordance with claim 15 wherein said at least one metering element includes means to prevent the premature vaporisation of the liquid reaction medium therein.

19. An exhaust gas cleaning system in accordance with claim 18 wherein said means a thermal insulation on said metering element relative to the flow of exhaust gas.

20. An exhaust gas cleaning system in accordance with claim 18 wherein said means is a thermoelectric Peltier cooling element for the cooling of the liquid reaction solution flowing through said metering element.

21. An exhaust gas cleaning system in accordance with claim 15 further comprising a cooling jacket circumferentially surrounding said feed line, a coolant line for the supply of coolant to said jacket and a coolant line for the removal of coolant from said jacket.

22. An exhaust gas cleaning system in accordance with claim 21 further comprising a distributor element communicatiing with said feed line to conduct the liquid reaction solution therethrough and passing through said cooling jacket for a flow of the coolant therearound.

23. An exhaust gas cleaning system in accordance with claim 22 wherein said cooling jacket includes a pair of concentric tubes disposed concentrically of said feed line.

24. An exhaust gas cleaning system in accordance with claim 15 further comprising a U-shaped tube having a pair of legs for passage of a coolant therethrough, said feed line being disposed in and passing through one of said legs of said U-shaped tube.

25. An exhaust gas cleaning system in accordance with claim 15 further comprising a tube having a partition wall therein separating said tube into two parallel passageways for the flow of coolant therethrough, said feed line being disposed in and passing through one of said passageways of said tube.

26. In combination
a diesel engine;
a closed passage for conveying a NOₓ containing flow of exhaust gas from said diesel engine;
at least one metering element for the introduction of a liquid reaction solution into the flow of exhaust gas,
a vaporiser downstream of said metering element relative to the flow of exhaust gas, said vaporiser having surfaces arranged in the flow of exhaust gas onto which the liquid reaction solution is applied and vaporised; and
a catalytic converter downstream of said vaporiser for receiving the flow of exhaust gas and the vaporised liquid reaction solution.

27. A method for the cleaning of exhaust gases containing NOₓ, said method including the steps of
introducing a NOₓ containing flow of exhaust gas from an exhaust gas source into a passage,
introducing a liquid reaction solution into the flow of exhaust gas,
vaporising the liquid reaction solution on a surface of the vaporiser into the flow of exhaust gas, and
reacting the vaporised reaction solution with NOₓ in the flow of exhaust gas in a catalytic converter.

28. A method in accordance with claim 27 further comprising the step of mixing the flow of exhaust gas and vaporised reaction solution upstream of the catalytic converter relative to the flow of exhaust gas.

29. A method in accordance with claim 27 further comprising the step of reducing NOₓ in the catalytic converter with ammonia contained in the vaporised reaction solution to N₂ in the presence of oxygen.

30. A method in accordance with claim 27 wherein the liquid reaction solution is a urea-water solution.
